(19) United States
(12) Patent Application Publication
(10) Pub. No.: US 2014/0214241 A1
(43) Pub. Date: Jul. 31, 2014

(54) Remotely activating an event in a vehicle using Wi-Fi Direct

(71) Applicant: HCL Technologies Limited, Chennai (IN)

(72) Inventors: Kumaralingam Ramamoorthy, Chennai (IN); Vengadassalabady Ramanouudjam, Chennai (IN); Rahul Ganapathy Subramaniam, Chennai (IN); Joy Esther Samuel, Chennai (IN)

(21) Appl. No.: 13/905,012

(22) Filed: May 29, 2013

(30) Foreign Application Priority Data
Jan. 30, 2013 (IN) 418/CHE/2013

(51) Int. Cl. G06F 17/00

(52) U.S. Cl. CPC G06F 17/00
USPC 701/2

(57) ABSTRACT

The embodiment provides a method for remotely activating an event in a vehicle using a Wi-Fi Direct (WFD) network. The method includes establishing a WFD based connection with an electronic device in the WFD network and receiving information associated with the vehicle using the WFD based connection. Further, the method includes remotely activating the events in the vehicle based on the information associated with the vehicle.

### PRIORITY DETAILS

The present application claims priority from Indian Application Number 418/CHE/2013, filed on 30th Jan. 2013, the disclosure of which is hereby incorporated by reference herein.

### TECHNICAL FIELD

The embodiments herein relate to smart electronic devices using Wi-Fi Direct, and more particularly, to a mechanism for remotely activating an event in a vehicle using Wi-Fi Direct and smart devices.

### BACKGROUND

A Wi-Fi Direct (WFD) is a network system suggested by the Wi-Fi Alliance that enables Wi-Fi devices to be connected to each other in a peer-to-peer (P2P) fashion without participating in a home network, an office network, a hot-spot network, and the like. It is often desirable to be able to cause an event in a vehicle to occur using remote control. The remote control can be used to perform various functions, such as for example, keyless locking/unlocking, starting/closing engine, opening/closing window, opening/closing mirror, activating/deactivating vehicle entertainment system, and the like.

Different methods and systems are proposed to remotely control and manage the vehicles over a communication network. Conventional systems and methods includes using remote transmitters, remote keys, and radio frequencies with a set of buttons for each function to remotely control and manage the vehicles over the communication network, while constantly using the network infrastructure which may increase the overall cost of the system. Such remote transmitters, remote keys, and radio frequencies can be more prone to the interference and can be easily hacked. Further, the accidental press of the remote keys can lead to activation of vehicle doors and the doors status may not be known to a user, unless the user manually checks the status.

Though the existing systems and methods are effective to a degree in remotely controlling the vehicles but include both advantages and disadvantages in terms of performance, range, security, ease of use, cost, user experience, ubiquity, optimization, alerts, and network infrastructure used.

### SUMMARY

Accordingly the embodiment provides a method for remotely activating an event in a vehicle using a Wi-Fi Direct (WFD) network. The method includes establishing a WFD based connection with an electronic device in the WFD network and receiving information associated with the vehicle using the WFD based connection. Further, the method includes remotely activating the events in the vehicle based on the information associated with the vehicle.

Furthermore, the method includes configuring a WFD interface on the vehicle and identifying the vehicle using a WFD identifier associated with the vehicle in the WFD network. Furthermore, the method includes authenticating the vehicle in the WFD network and encoding/decoding the information associated with the vehicle in the WFD network. Furthermore, the method includes providing alerts to a user based on the information associated with the vehicle and display the information associated with the alerts on the vehicle and/or the electronic device.

Accordingly the embodiment provides a system for remotely activating an event in a vehicle using a Wi-Fi Direct (WFD) network. The system includes an electronic device configured to establish a WFD based connection with the vehicle in the WFD network and receive information associated with the vehicle using the WFD based connection. Further, the electronic device is configured to remotely activate the events in the vehicle based on the information associated with the vehicle.

Further, the system includes an engine control interface unit configured to provide the information associated with the vehicle and a WFD interface unit configured on the vehicle and/or the electronic device to establish the WFD based connection in the WFD network. Furthermore, the electronic device is configured to identify the vehicle using a WFD identifier associated with the vehicle. Furthermore, the electronic device is configured to authenticate the vehicle and identify encode/decode the information associated with the vehicle in the WFD network. Furthermore, the electronic device is configured to provide alerts to a user based on the information associated with the vehicle and display the information associated with the alerts on the vehicle and/or the electronic device.

These and other aspects of the embodiments herein will be better understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 illustrates generally, among other things, a system accessing a WFD network, according to the embodiments disclosed herein;

FIG. 2 expands features and functions of the system as described in the FIG. 1, according to embodiments described herein;

FIG. 3 is a sequence diagram illustrating operations performed by the system as described in the FIG. 1, according to the embodiments disclosed herein;

FIG. 4 is a flowchart illustrating a method for remotely activating an event in a vehicle using the WFD network, according to the embodiments disclosed herein; and

FIG. 5 illustrates a computing environment implementing the method and system as disclosed in the embodiments herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for remotely activating an event in a vehicle using Wi-Fi Direct (WFD) network. The vehicle can be configured to include WFD interface(s), such as to establish a connection with one or more electronic devices in the WFD network. The WFD interface enables the vehicle to connect with other electronic devices in a peer-to-peer (P2P) fashion without participating in a home network, an office network, a hot-spot network, or using network infrastructure. Upon establishing the connection, the electronic device can be configured to receive the information associated with the vehicle. The electronic device identifies each vehicle using the WFD identifier associated with the vehicle. The electronic device can be configured to remotely activate an event in the vehicle based on the information associated with the vehicle. Further, a plurality of rules can be implemented on the electronic device to provide effective, efficient, and reliable decision/support for performing the event in the vehicle. Furthermore, the electronic device can be configured to receive respective alerts about the various status of the vehicle.

The proposed system and method is simple, robust, dynamic, inexpensive, and reliable for remotely activating, managing, and controlling events in the vehicle using the WFD. The system can be used to provide customized user specific applications to remotely activate, control, and manage the vehicle functions thereby avoiding the risk of misuse of the vehicles. Unlike the convention systems, the use of WFD-enabled device(s) and network(s) can increases the speed, range, and performance with reasonable system cost and time. The proposed system can be used to establish a P2P connection between the devices, such as to reduce the risk of interference and provide highly secure communications throughout the system. Further, the proposed system and method can be implemented on the existing infrastructure and may not require extensive set-up or instrumentation.

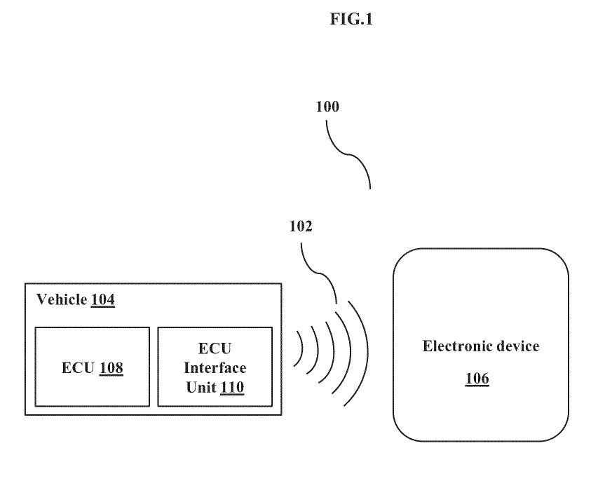

FIG. 1 illustrates generally, among other things, a system 100 accessing a Wi-Fi Direct (WFD) network 102, according to the embodiments disclosed herein. The system 100 can include one or more vehicles 104 (hereafter referred as vehicle 104) and one or more electronic devices 106 (hereafter referred as electronic device 106) communicating among each other using the WFD network 102.

In an embodiment, the vehicle 104 described herein can include for example, but not limited to, a car, bus, train, bike, truck, aircraft, or any other type of vehicle capable of including sufficient firmware to communicate with the electronic devices 106 over the WFD network 102. Further, the vehicle 104 can be configured to include or be coupled to an engine control unit (ECU) 108 configured to control the functions of the vehicle 104. In an embodiment, the ECU 108 can be configured to include or be coupled to an ECU interface unit 110. The ECU interface unit 110 can be configured to retrieve the information associated with the vehicle 104. The ECU interface unit 110 described herein can be configured to include WFD capabilities, such as to pair or connect with any electronic device 106 over the WFD network 102. Further, the ECU interface unit 110 can be configured to dynamically establish a connection with the electronic device(s) 106 and perform other functions over the WFD network 102.

In an embodiment, the electronic devices 106 described herein can include for example, but not limited to, smart phones, personal digital assistances (PDAs), communicators, wireless electronic devices, laptops, computers, desktops, cloud devices, servers, combination thereof, or any other electronic devices including sufficient firmware to communicate with the vehicle 104 over the WFD network 102. Further, the electronic device 106 can be configured to include WFD interface(s) such as to dynamically establish a connection with the vehicle 104 in the WFD network 102.

In an example, the system 100 can be configured to include Wi-Fi display certified devices, such as to display information among each other. The vehicle 104 and the electronic device 106, within the WFD network 102, can be directly connected to each other without using a wireless local area network (WLAN) access point (AP). For such a direct connection between the vehicle 104 and the electronic device 106, the system 100 can be configured to use a new firmware protocol (such as Wi-Fi Direct). The protocol can enables the vehicle 104 and the electronic devices 106 to connect with each other in a peer-to-peer (P2P) fashion without participating in a home network, an office network, a hot-spot network, WLAN AP, or using any other network infrastructure. The use of such WFD devices and network can increases the overall system performance, speed, and range thereby significantly reducing the system cost.

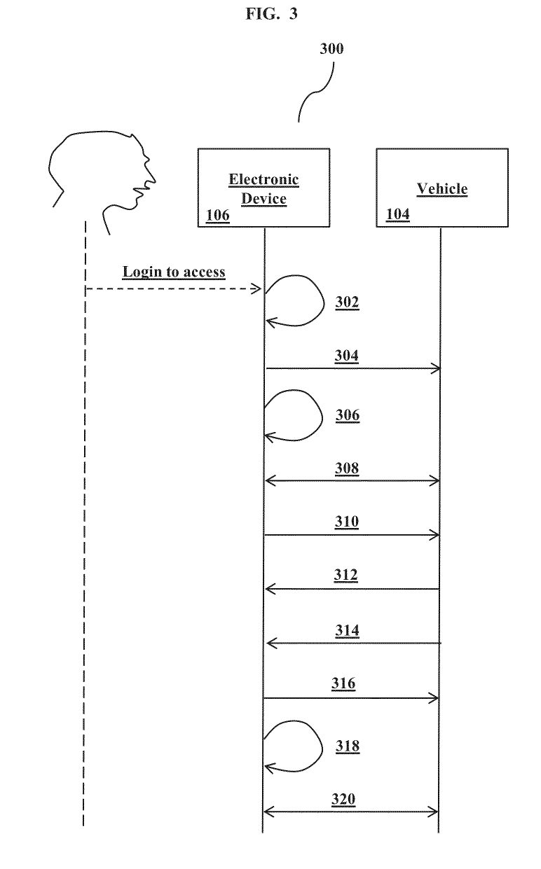

In the FIG. 1, the vehicle 104 can be any type of vehicle including ECU interface unit 110 configured thereon, whereas the electronic device 106 is a smart device, though it is understood that another exemplary embodiment is not limited thereto. The vehicle 104 and electronic device 106 can establish a direct P2P connection between each other using the WFD network 102. Further, the direct P2P connection can reduces the risk of inference and provide highly secure communications throughout the system 100. Further, the operations performed between the vehicle 104 and the electronic device 106, are described in conjunction with FIG. 3.

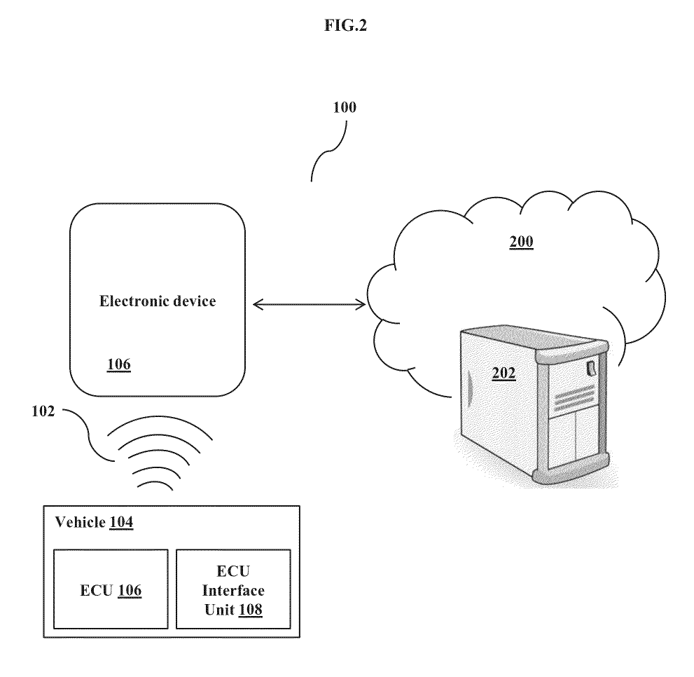

FIG. 2 expands features and functions of the system 100 as described in the FIG. 1, according to embodiments described herein. In an embodiment, the vehicle 104 can be configured to dynamically connect with the electronic device 106 over the WFD network 102. The vehicle 104 can be configured to include ECU interface unit 110 to dynamically create a secure and unique communication channel with the electronic device 106. In an example, the ECU interface unit 110 can be configured to interface with various interfaces such as Flex-Ray, Digital and Analog input/output, controller area network (CAN), local interconnect network (LIN), serial ports, and the like, such as to establish a WFD based connection with the electronic device 106 over the WFD network 102.

In an embodiment, upon establishing the WFD based connection, the electronic device 106 can be configured to receive information associated with the vehicle 104. In an embodiment, the information associated with the vehicle 104 can include for example, but not limited to, vehicle main doors status (such as opened, closed, locked, unlocked, and the like), side mirrors status (opened, closed, partial open/close, and the like), vehicle entertainment system data (such as music on/off, FM radio available stations, and the like), fuel level, windows status, vehicle position data (such as moving, stationary, and the like), fuel tank pressure voltage, engine load, engine Revolutions/Rotation per minute (RPM), vehicle speed, battery voltage, engine coolant temperature, total number of miles travelled by the vehicle, insurance details, pollution details, and the like. In an embodiment, the information can be encoded/encrypted before sending to the electronic device 106. The system 100 can be configured to use an Advanced Encryption Standard (AES) 256-bit encryption technique to encrypt the information and provide security to the information associated with the vehicle 104.

Further, electronic device 106 can be configured to remotely activate an event in the vehicle 104 based on the information associated with the vehicle 104. In an embodiment, the events described herein can include for example, but not limited to, opening/closing of doors, opening/closing of windows, opening/closing of mirrors, keyless locking/unlocking, pre-heating and cooling, starting/stopping engines, power on/off and control of vehicle entertainment system, opening/closing of a shutter, opening/closing of curtain, opening/closing of vehicle GPS system, or any other event. In an embodiment, a plurality of rules can be implemented on the electronic device 106 to provide effective, efficient, and reliable decision/support for performing the events in the vehicle 104. The electronic device 106 can be configured to provide a customized user specific application for the user to remotely activate, control, manage, and perform the events in the vehicle 104, such as to avoid the risk of misuse of the vehicle 104. The detailed operations performed between the vehicle 104 and the electronic device 106, are described in conjunction with the FIG. 3.

In an embodiment, the electronic device 106 can be configured to communicate with a cloud platform 200 for remotely activating the events in the vehicle 104. The cloud platform 200 include a cloud server 202 configured to implement a plurality of rules to provide effective, efficient, and reliable decision/support for performing the events in the vehicle 104. In an embodiment, the electronic device 106 can be configured to connect with the cloud devices (for e.g., the server 202) using a communication network. The communication network described herein can include for example, wireless communication network, wire-line communication network, global system for mobile communication (GSM) network, cellular communication network, local area network (LAN), wide area network (WAN), Wi-Fi Direct network (WFD), combination thereof, or any other network.

FIG. 3 is a sequence diagram illustrating operations 300 performed by the system 100 as described in the FIG. 1, according to the embodiments disclosed herein. In an embodiment, at 302, a user can login the electronic device 106 to access the vehicle information and perform one or more events. In an example, the user can use a customized application to provide the login information such as user name, password, and the like to access the vehicle information 104. The secure access to the vehicle information can be provided to avoid the risk of misuse of the vehicle 104.

In an embodiment, at 304, the electronic device 106 can dynamically send a request to establish a connection with the vehicle 104 over the WFD network 102. In an example, the ECU interface unit 110 can be used to dynamically receive the request for establishing a WFD based connection with the electronic device 106. In an example, the driver, or a user of the electronic device 106, or any other user of the vehicle can also manually send the request by pressing a WPS-based button present on the vehicle 104.

In an embodiment, at 306, upon sending the request, the electronic device 106 can enable a group owner to create a P2P connection. In an example, the electronic device 106 can be configured to communicate with Dynamic Host Configuration Protocol (DHCP) server of the group owner to establish a WFD based P2P connection with the vehicle 104. Further, the electronic device 106 can be configured to setup multiple P2P links with the vehicles 104 to monitor multiple vehicle information at substantially the same time.

In an embodiment, at 308, the electronic device 106 can authenticate the vehicle 104 and create the WFD based P2P connection with the vehicle 104. In an example, the electronic device 106 can be configured to perform a 4-way handshake between the vehicle 104 and the electronic device 106. The group owner can perform a peer (the vehicle 104) discovery to initiate a communication and perform the 4-way handshake between the vehicle 104 and the electronic device 106. Further, in response to successful authentication, the electronic device 106 can be configured to create a WFD based P2P connection with the vehicle 104, without using a home network, an office network, a hot-spot network, WLAN AP, or any other network infrastructure. Furthermore, a secure communication channel can be provided by using the WFD based P2P connection thereby significantly reducing the risk of interference with other network device and radio frequencies.

In an embodiment, at 310, the electronic device 106 can request a WFD identifier associated with the vehicle 104. In an example, the WFD identifier can be used by the electronic device 106 to uniquely identify the vehicle 104 in the WFD network 102, thereby eliminating the risk of cross connection with other vehicles present in the WFD network 102. The WFD identifier described herein can include for example, a WFD Media Access Control (MAC) address associated with the vehicle 104.

In an embodiment, at 312, upon receiving the request, the vehicle 104 can send the associated WFD identifier to the electronic device 106. In an example, where the vehicle is not WFD enabled, the electronic device 106 can use the normal Wi-Fi MAC address associated with the vehicle to uniquely identify the vehicle 104 in the WFD network 102.

In an embodiment, at 314, the electronic device 106 can receive the information associated with the vehicle 104. In an example, the electronic device 106 can be configured to send a request to the vehicle 104, such as to receive the information associated with the vehicle 104. In an example, a user of the electronic device 106 can customize the request by selecting required information of the vehicle 104. The ECU interface unit 110 can be configured to configure to retrieve and provide the information associated with the vehicle 104. The information associated with the vehicle 104 can include for example, but not limited to, vehicle main doors status (such as opened, closed, locked, unlocked, and the like), side mirrors status (opened, closed, partial open/close, and the like), vehicle entertainment system data (such as music on/off, FM radio available stations, and the like), fuel level, windows status, vehicle position data (such as moving, stationary, and the like), fuel tank pressure voltage, engine load, engine RPM, vehicle speed, battery voltage, engine coolant temperature, total number of miles travelled by the vehicle, insurance details, pollution details, or any other information. In an example, the information can be encoded or encrypted before sending to the electronic device 106. For example, the vehicle 104 can be configured to use the AES 256-bit encryption technique to encode/encrypt the information, such as to provide security to the information associated with the vehicle 104.

In an embodiment, at 316, the electronic device 106 can be configured to remotely activate one or more events in the vehicle 104. The events described herein can include for example, but not limited to, opening/closing of doors, opening/closing of windows, opening/closing of minors, keyless locking/unlocking, pre-heating and cooling, staring/stopping engines, power on/off and control of vehicle entertainment system, opening/closing of shutter, opening/closing of curtain, opening/closing of vehicle GPS system, and the like. In an example, a plurality of rules can be implemented on the electronic device 106 to provide effective, efficient, and reliable decision/support for performing the events in the vehicle 104. For example, if an event related to keyless unlocking of the vehicle doors needs to be activated then the electronic device 106 can execute one or more rules to ensure that the vehicle is not running and is in stationary position to open the doors. Similarly, if an event related to starting the vehicle engine needs to be activated then the electronic device 106 can execute one or more rules to ensure that the vehicle gears are in neutral position. Further, the electronic device 106 can be configured to communicate with other components and devices present in the cloud to provide effective, efficient, and reliable decision/support for performing the events in the vehicle 104.

In an embodiment, at 318, the electronic device 106 can provide alerts to the user based on the information associated with the vehicle 104. In an example, if the vehicle 104 is remotely unlocked and is started running without locking the doors then the electronic device 106 can be configured to provide alerts to the user to remotely lock the unlocked doors.

In an embodiment, at 320, the electronic device 106 can display the activated events to the users of the electronic device 106 and the vehicle 104. In an example, the electronic device 106 and/or the vehicle 104 can be configured to include a user interface such as to provide a visual presentation of the information associated vehicle, activated events, alerts, and the like.

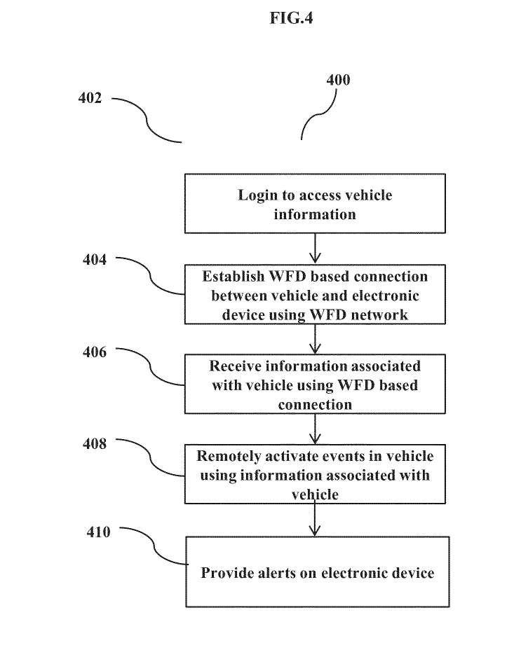

FIG. 4 is a flowchart illustrating a method 400 for remotely activating an event in a vehicle using the WFD network 102, according to the embodiments disclosed herein. In an embodiment, at step 402, the method 400 includes logging a user to access the vehicle information. In an example, the method 400 allows the user to login the electronic device 106 to access the vehicle information and perform one or more events. The user can use a customized application to provide the login information such as user name, password, and the like to access the vehicle information 104. The secure access to the vehicle information can be provided to avoid the risk of misuse of the vehicle 104.

In an embodiment, at step 404, the method 400 includes establishing a WFD based connection between the vehicle 104 and the electronic device 106 using the WFD network 106. In an example, the method 400 allows the electronic device 106 to send a request via the WFD interface to dynamically establish the WFD based connection with the vehicle 104. The electronic device 106 enables a group owner to create a P2P connection. Further, the method 400 allows the electronic device 106 to authenticate the vehicle 104 for establishing the connection with the electronic device 106. The group owner can discover a peer (the vehicle 104) and perform 4-way handshake between the vehicle 104 and the electronic device 106. Further, in response to successful authentication, the electronic device 106 creates the WFD based P2P connection with the vehicle 104, without using a home network, an office network, a hot-spot network, WLAN AP, or any other network infrastructure. Furthermore, a secure communication channel can be provided by using the WFD based P2P connection thereby significantly reducing the risk of interference with other network device and radio frequencies. Similarly, the electronic device 106 can setup multiple P2P links with the vehicles 104 at substantially the same time. The electronic device 106 can identify each vehicle based on the WFD identifier associated with the vehicle 106 and eliminate the risk of cross connection with other vehicles present in the WFD network 102.

In an embodiment, at step 406, the method 400 includes receiving information associated with the vehicle 104 using the WFD based connection. In an example, the method 400 allows the electronic device 106 to send a request to the vehicle 104 for receiving the information associated with the vehicle 104. The information associated with the vehicle 104 can include for example, but not limited to, vehicle main doors status (such as opened, closed, locked, unlocked, and the like), side mirrors status (opened, closed, partial open/close, and the like), vehicle entertainment system data (such as music on/off, FM radio available stations, and the like), fuel level, windows status, vehicle position data (such as moving, stationary, and the like), fuel tank pressure voltage, engine load, engine RPM, vehicle speed, battery voltage, engine coolant temperature, total number of miles travelled by the vehicle, insurance details, pollution details, and the like. The information can be encoded or encrypted before sending to the electronic device 106. The AES 256-bit encryption technique can be used to encode/encrypt the information to provide security to the information associated with the vehicle 104.

In an embodiment, at step 408, the method 400 includes remotely activating one or more events in the vehicle 104 using the information associated with the vehicle 104. The events described herein can include for example, but not limited to, opening/closing of doors, opening/closing of windows, opening/closing of mirrors, keyless locking/unlocking, pre-heating and cooling, staring/stopping engines, power on/off and control of vehicle entertainment system, opening/closing of shutter, opening/closing of curtain, opening/closing of vehicle GPS system, and the like. In an example, the method 400 allows the electronic device 106 to execute a plurality of rules to provide effective, efficient, and reliable decision/support for performing the events in the vehicle 104. Further, the method 400 allows the electronic device 106 to communicate with other components and devices present in the cloud to provide effective, efficient, and reliable decision/support for performing the events in the vehicle 104.

In an embodiment, at step 410, the method 400 includes providing alerts to the user based on the information associated with the vehicle 104. In an example, the method 400 includes monitoring the information associated with the vehicle 104 and providing respective alerts to the user. For example, if the vehicle is unlocked and is at stationary position then the method 400 allows the electronic device 106 to generate alerts for the user to lock the vehicle 106.

The various actions, steps, blocks, or acts described with respect to the FIGS. 3 and 4 can be performed in sequential order, in random order, simultaneously, parallel, or a combination thereof. Further, in some embodiments, some of the steps, blocks, or acts can be omitted, skipped, modified, or added without departing from the scope of the embodiment.

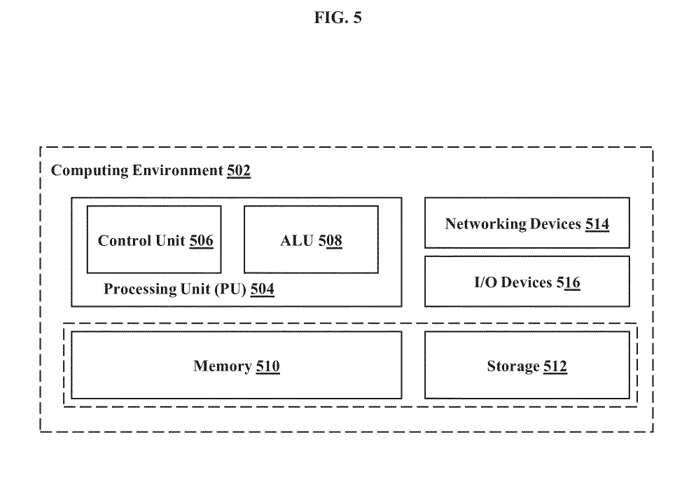

FIG. 5 illustrates a computing environment 502 implementing the method and systems as disclosed in the embodiments herein. As depicted the computing environment 502 comprises at least one processing unit 504 that is equipped with a control unit 506 and an Arithmetic Logic Unit (ALU) 508, a memory 510, a storage unit 512, plurality of networking devices 514 and a plurality Input output (I/O) devices 516. The processing unit 504 is responsible for processing the instructions of the algorithm. The processing unit 504 receives commands from the control unit 506 in order to perform its processing. Further, any logical and arithmetic operations involved in the execution of the instructions are computed with the help of the ALU 508.

The overall computing environment 502 can be composed of multiple homogeneous and/or heterogeneous cores, multiple CPUs of different kinds, special media and other accelerators. The processing unit 504 is responsible for processing the instructions of the algorithm. Further, the plurality of processing units 504 may be located on a single chip or over multiple chips.

The algorithm comprising of instructions and codes required for the implementation are stored in either the memory unit 510 or the storage 512 or both. At the time of execution, the instructions may be fetched from the corresponding memory 510 and/or storage 512, and executed by the processing unit 504.

In case of any hardware implementations various networking devices 514 or external I/O devices 516 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 5 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for remotely activating an event in a vehicle using a Wi-Fi Direct (WFD) network, the method comprising:
establishing a WFD based connection with at least one electronic device in said WFD network;
receiving information associated with said vehicle using said WFD based connection; and
remotely activating at least one event in said vehicle based on said information associated with said vehicle.

2. The system of claim 1, wherein said method further comprises implementing at least one rule to remotely perform said at least one event in said vehicle.

3. The method of claim 1, wherein said method further comprises configuring a WFD interface on at least one of said vehicle and said electronic device.

4. The method of claim 1, wherein said method further comprises identifying said vehicle using a WFD identifier associated with said vehicle in said WFD network.

5. The method of claim 1, wherein said method further comprises authenticating said vehicle in said WFD network.

6. The method of claim 1, wherein said method further comprises encoding said information associated with said vehicle in said WFD network.

7. The method of claim 1, wherein said method further comprises decoding said information associated with said vehicle in said WFD network.

8. The method of claim 1, wherein said method further comprises providing at least one alert on said electronic device based on said information associated with said vehicle.

9. The method of claim 1, wherein said method further comprises displaying said information associated with said vehicle alerts on said electronic device.

10. A system for remotely activating an event in a vehicle using a Wi-Fi Direct (WFD) network, the system comprising at least one electronic device configured to:
establish a WFD based connection with said vehicle in said WFD network;
receive information associated with said vehicle using said WFD based connection; and
remotely activate at least one event in said vehicle based on said information associated with said vehicle.

11. The system of claim 10, wherein said electronic device is further configured to implement at least one rule to remotely perform said at least one event in said vehicle.

12. The system of claim 10, wherein said system further comprises a WFD interface configured on at least one of said vehicle and said electronic device.

13. The system of claim 10, wherein said electronic device is further configured to identify said vehicle using a WFD identifier associated with said vehicle in said WFD network.

14. The system of claim 10, wherein said electronic device is further configured to authenticate said vehicle in said WFD network.

15. The system of claim 10, wherein said vehicle comprises an engine control interface unit configured to provide said information associated with said vehicle.

16. The system of claim 10, wherein said electronic device is further configured to encode said information associated with said vehicle in said WFD network.

17. The system of claim 10, wherein said electronic device is further configured to decode said information associated with said vehicle in said WFD network.

18. The system of claim 10, wherein said electronic device is further configured to provide at least one alert based on said information associated with said vehicle.

19. The system of claim 10, wherein said electronic device is further configured to display said information associated with said vehicle.
